(19) United States
(12) Patent Application Publication
(10) Pub. No.: US 2023/0405366 A1
(43) Pub. Date: Dec. 21, 2023

(54) CENTRALIZED CONTROL OF DISTRIBUTED OXYGEN SYSTEM

(71) Applicant: B/E AEROSPACE, INC., Winston Salem, NC (US)

(72) Inventors: BRYCE C. BAKER, Raymore, MO (US); ASHISH SHRIKHANDE, BANGALORE (IN)

(73) Assignee: B/E AEROSPACE, INC., Winston Salem, NC (US)

(21) Appl. No.: 17/952,087

(22) Filed: Sep. 23, 2022

(30) Foreign Application Priority Data
Jun. 21, 2022 (IN) 202211035528

(51) Int. Cl. A62B 9/02; A62B 7/02; F16K 17/04

(52) U.S. Cl. CPC A62B 9/027; A62B 7/02; F16K 17/048

(57) ABSTRACT

An oxygen supply system for delivering oxygen to passengers in an aircraft in an event of a loss of cabin pressure includes a source of oxygen, a passenger service unit, and a main controller. The passenger service unit includes a face mask configured to facilitate a flow of an accumulated volume of oxygen from the source of oxygen, and a sensor configured to detect at least one of an ambient pressure, an airflow in a first direction, or an airflow in a second direction. The main controller is configured to determine at least one of the ambient pressure, the airflow being in the first direction, or the airflow being in the second direction, and command delivery of oxygen from the source of oxygen to the face mask in response to the determination.

### CROSS-REFERENCE TO RELATED APPLICATIONS

This application claims priority to, and the benefit of, India Patent Application No. 202211035528 (DAS CODE: 24DD), filed Jun. 21, 2022, and titled “CENTRALIZED CONTROL OF DISTRIBUTED OXYGEN SYSTEM,” which is incorporated by reference herein in its entirety for all purposes.

### FIELD

The present disclosure relates generally to emergency oxygen supply systems and, more particularly, to intelligent controllers for oxygen systems for aircrafts.

### BACKGROUND

Emergency oxygen supply systems are commonly installed on aircraft for the purpose of supplying oxygen to passengers upon loss of cabin pressure at altitudes above about 12,000 feet. Such systems typically include a face mask adapted to fit over the mouth and nose which is released from an overhead storage compartment when needed. Supplemental oxygen delivered by the mask increases the level of blood oxygen saturation in the mask user beyond what would be experienced if ambient air were breathed at the prevailing cabin pressure altitude condition. The flow of oxygen provided thereby is calculated to be sufficient to sustain all passengers until cabin pressure is reestablished or until a lower, safer altitude can be reached.

Each such face mask may have a reservoir bag attached thereto into which a constant flow of oxygen is directed upon deployment of the system and upon activation of the individual face mask via a pull cord. The oxygen is supplied continuously at a rate that is calculated to accommodate a worst-case scenario, namely to satisfy the need of a passenger with a significantly larger than average tidal volume who is breathing at a faster than average respiration rate in response to cabin pressure loss at a maximum cruising altitude. A total of three valves that are associated with the mask serve to coordinate flows between the bag and the mask, and between the mask and the surroundings. An inhalation valve serves to confine the oxygen flowing into the bag to the bag while the passenger is exhaling as well as during the post-expiratory pause and at all times also prevents any flow from the mask into the bag. In response to the passenger inhaling, the inhalation valve opens to allow for the inhalation of the oxygen that has accumulated in the bag. Upon depletion of the accumulated oxygen, the dilution valve opens to allow cabin air to be drawn into the mask. The continuing flow of oxygen into the bag and through the open inhalation valve into the mask is thereby diluted by the cabin air that is inhaled during the balance of the inhalation phase. During exhalation, the exhalation valve opens to allow a free flow from the mask into the surroundings while the inhalation valve closes to prevent flow from the mask back into the bag. All three valves remain closed during the post-expiratory pause while oxygen continues to flow into the reservoir bag.

Inefficiencies in an emergency oxygen supply system may cause the oxygen storage or oxygen generation means to be larger and therefore weigh more, which has an adverse impact on the payload capacity and fuel consumption of the aircraft.

### SUMMARY

An oxygen supply system for delivering oxygen to passengers in an aircraft in an event of a loss of cabin pressure is disclosed herein. The oxygen supply system includes a source of oxygen, a passenger service unit, and a main controller. The passenger service unit includes a face mask configured to facilitate a flow of a bolus volume of oxygen from the source of oxygen, and a sensor configured to detect at least one of an ambient pressure, an airflow in a first direction, or an airflow in a second direction. The main controller is configured to determine at least one of the ambient pressure, the airflow being in the first direction, or the airflow being in the second direction, and command delivery of oxygen from the source of oxygen to the face mask in response to the determination.

In various embodiments, the oxygen supply system includes a plurality of passenger service units. The main controller is configured to control each of the plurality of passenger service units.

In various embodiments, the source of oxygen supplies each of the plurality of passenger service units.

In various embodiments, the source of oxygen includes a container of compressed oxygen gas.

In various embodiments, an inlet valve of the passenger service unit remains closed in response to the airflow being in the first direction.

In various embodiments, the inlet valve is opened in response to the airflow being in the second direction.

In various embodiments, the accumulated volume of oxygen is delivered to a reservoir bag coupled to the face mask prior in response to the airflow being in the second direction to meter a constant flow.

In various embodiments, the main controller is configured to open and close the inlet valve.

In various embodiments, the main controller is configured to determine a volume of oxygen as a function of at least one of the ambient pressure or a rate of airflow being above a predetermined threshold.

An article of manufacture including a tangible, non-transitory computer-readable storage medium having instructions stored thereon for controlling a passenger service unit, in response to execution by a controller, cause the controller to perform operations is disclosed herein. The operations include determining at least one of an ambient pressure of an aircraft cabin or an airflow through a face mask in a first direction, or an airflow through the face mask in a second direction, and commanding delivery of oxygen from a source of oxygen to the face mask in response to the determination.

In various embodiments, the passenger service unit comprises the face mask and a sensor. The face mask is configured to facilitate a flow of an accumulated volume of oxygen from a source of oxygen. The sensor is configured to detect at least one of the ambient pressure, the airflow being in the first direction, or the airflow being in the second direction.

In various embodiments, the controller is configured to communicate with the sensor such that the operations further comprise receiving data from the sensor, the data indicative of at least one of the ambient pressure of the aircraft cabin, the airflow being in the first direction, or the airflow being in the second direction.

In various embodiments, the operations further include controlling a plurality of passenger service units. The controller is operatively coupled to each of the plurality of passenger service units.

In various embodiments, the operations further include commanding delivery of oxygen from the source of oxygen to each of the plurality of passenger service units.

In various embodiments, the source of oxygen includes a container of compressed oxygen gas.

In various embodiments, the operations further include commanding an inlet valve to open and commanding the inlet valve to close.

In various embodiments, the inlet valve of the passenger service unit remains closed in response to the airflow being in the first direction.

In various embodiments, the inlet valve is opened in response to the airflow being in the second direction.

In various embodiments, the accumulated volume of oxygen is delivered to a reservoir bag coupled to the face mask in response to the airflow being in the second direction to meter a constant flow.

In various embodiments, the operations further include determining the volume of oxygen as a function of at least one of the ambient pressure or a rate of airflow being above a predetermined threshold.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A illustrates a view of a cabin of an aircraft, in accordance with various embodiments;

FIG. 1B illustrates a perspective view of a cabin of an aircraft, in accordance with various embodiments;

FIG. 2 illustrates a schematic view of an oxygen system, in accordance with various embodiments;

FIG. 3 illustrates a schematic view of an oxygen system, in accordance with various embodiments;

FIG. 4 illustrates a schematic view of an oxygen system, in accordance with various embodiments; and

FIG. 5 illustrates a schematic view of a main controller of an oxygen system, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

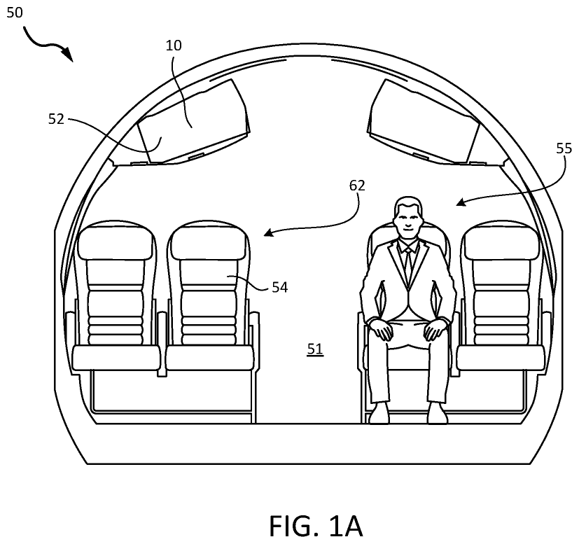

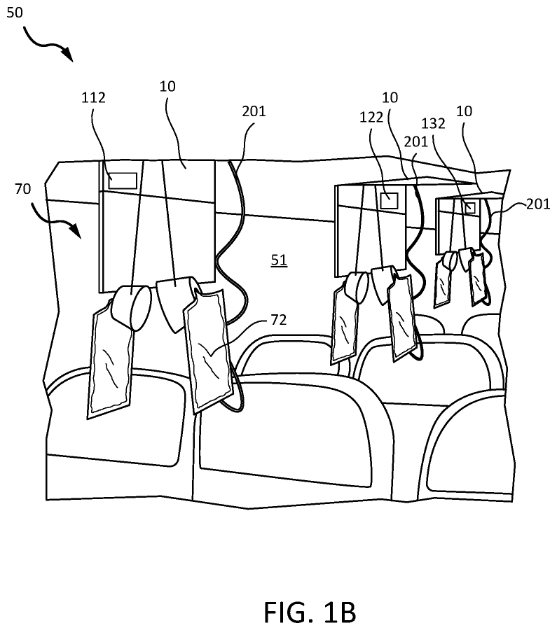

With reference to FIG. 1A, a cabin 51 of an aircraft 50 is shown, according to various embodiments. The aircraft 50 may be any aircraft such as an airplane, a helicopter, or any other aircraft. The aircraft 50 may include a passenger service unit (PSU) 10 corresponding to each row of seats 62. The cabin 51 may include overhead bins 52, passenger seats 54 forming the row of passenger seats 62 for supporting passengers 55, etc. In various embodiments, the PSU 10 may be integral with the overhead bins 52 or the PSU 10 may be separate from the overhead bins 52. The present disclosure is not limited in this regard.

Referring now to FIG. 1B, a perspective view of the cabin 51 of the aircraft 50 from FIG. 1A is illustrated with a plurality of oxygen mask assemblies 70 in a deployed position. Each mask assembly in the plurality of oxygen mask assemblies 70 may be deployed from a PSU 10. Each PSU may comprise a release mechanism (e.g., release mechanism 112, 122, 132), such as an actuator based lock or the like. The present disclosure is not limited in this regard and any release mechanism is within the scope of this disclosure.

In various embodiments, each oxygen mask assembly in the plurality of oxygen mask assemblies 70 comprises a tube assembly 201. The tube assembly 201 is configured to transfer a fluid (e.g., oxygen gas) from an oxygen source, or a compressed oxygen gas, to a respective oxygen mask 72. In this regard, each tube assembly (e.g., tube assembly 201) may comprise a fluid conduit configured to transfer the fluid from the oxygen source to the respective oxygen mask 72.

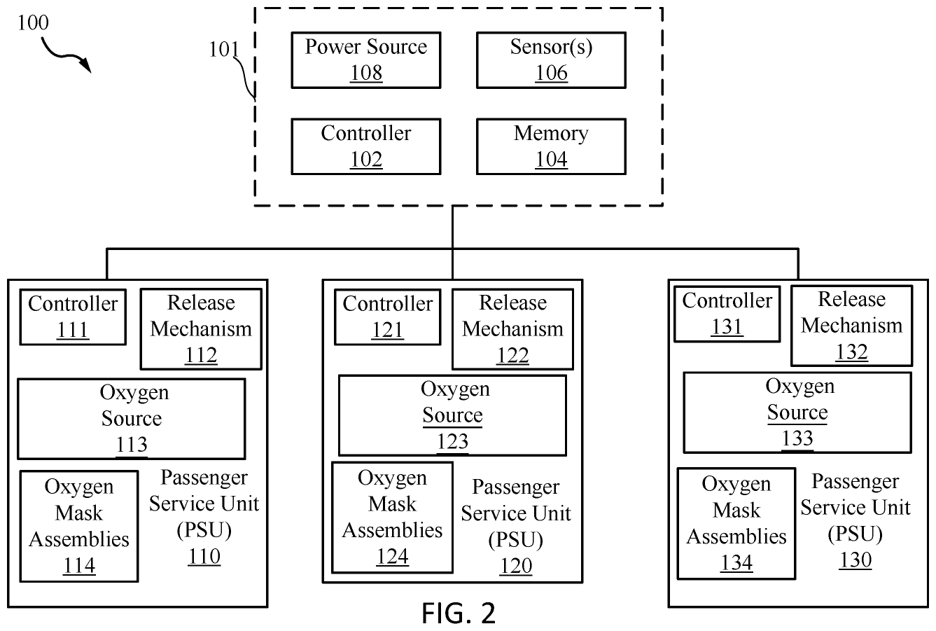

Referring now to FIG. 2 a schematic view of an oxygen system 100 for an aircraft cabin, is illustrated, in accordance with various embodiments. In various embodiments, the oxygen system 100 comprises a main control system 101 and a plurality of PSUs (e.g., first PSU 110, second PSU 120, third PSU 130, fourth PSU 140, etc.). Although illustrated as including three PSUs, the number of PSUs of an oxygen system 100 is not limited in this regard. For example, a PSU may be disposed in each row of seats disposed in a respective column of an aircraft cabin. For example, a cabin with rows and 3 columns may have 150 PSUs (e.g., each row in each column having a PSU). In various embodiments, the PSUs are not limited to rows in the aircraft cabin and may be placed throughout the aircraft cabin as well.

In various embodiments, the main control system 101 includes a controller 102 (e.g., a main controller) and a memory 104 (e.g., a database or any appropriate data structure; hereafter “memory 104” also may be referred to as “database 104”). The controller 102 may include one or more logic devices such as one or more of a central processing unit (CPU), an accelerated processing unit (APU), a digital signal processor (DSP), a field programmable gate array (FPGA), an application specific integrated circuit (ASIC), or the like (e.g., controller 102 may utilize one or more processors of any appropriate type/configuration, may utilize any appropriate processing architecture, or both). In various embodiments, the controller 102 may further include any non-transitory memory known in the art. The memory 104 may store instructions usable by the logic device to perform operations. Any appropriate computer-readable type/configuration may be utilized as the memory 104, any appropriate data storage architecture may be utilized by the memory 104, or both.

The database 104 may be integral to the control system 101 or may be located remote from the control system 101. The controller 102 may communicate with the database 104 via any wired or wireless protocol. In that regard, the controller 102 may access data stored in the database 104. In various embodiments, the controller 102 may be integrated into computer systems onboard an aircraft. Furthermore, any number of conventional techniques for electronics configuration, signal processing and/or control, data processing and the like may be employed. Also, the processes, functions, and instructions may include software routines in conjunction with processors, etc.

System program instructions and/or controller instructions may be loaded onto a non-transitory, tangible computer-readable medium having instructions stored thereon that, in response to execution by the processor, cause the controller 102 to perform various operations. The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media that were found in In Re Nuijten to fall outside the scope of patentable subject matter under 35 U.S.C. § 101.

The instructions stored on the memory 104 of the controller 102 may be configured to perform various operations, such as determining a cabin air pressure has dropped below a threshold pressure, commanding release of a plurality of oxygen masks, initiating a start of chemical oxygen generators, etc.

In various embodiments, the main control system 101 from FIG. 2 further comprises a power source 108 and sensor(s) 106. The power source 108 may comprise any power source known in the art, such as a battery, a solar source, an alternating current (AC) source, a rechargeable source, or the like. In various embodiments, the sensor(s) 106 may be spaced about the aircraft 50 from FIG. 1A. In various embodiments, the sensor(s) 106 may comprise pressure sensors. In this regard, the sensor(s) 106 may be configured to measure an aircraft cabin pressure and relay the measurements to the controller 102. Thus, the controller 102 may determine whether the aircraft pressure has dropped below a pressure threshold, and release the oxygen masks as described further herein.

In various embodiments, the sensors 106 may comprise any type of sensor that measures oxygen flowing properly in the oxygen system 100 (e.g., an oxygen gas detector, an oxygen sensor, or the like). The present disclosure is not limited in this regard. In various embodiments, the sensors 106 may be external to the tube assembly 201 or integrated within the tube assembly 201. In various embodiments, the sensors 204 may be disposed within a fluid conduit of the tube assembly 201 as described further herein.

In various embodiments, the main control system 101 is in operable communication with each PSU in the plurality of PSUs (e.g., PSUs 110, 120, 130). In various embodiments, each PSU comprises a local controller (e.g., controllers 111, 121, 131, 141). The local controllers 111, 121, 131, 141 may be configured to communicate with the main control system 101 located outside the PSU by ethernet, CAN, or another network communication protocol. Each local controller (e.g., controllers 111, 121, 131) may be in accordance with controller 102. For example, each local controller (e.g., controllers 111, 121, 131) may include one or more logic devices such as one or more of a central processing unit (CPU), an accelerated processing unit (APU), a digital signal processor (DSP), a field programmable gate array (FPGA), an application specific integrated circuit (ASIC), or the like (e.g., controllers 111, 121, 131) may utilize one or more processors of any appropriate type/configuration, may utilize any appropriate processing architecture, or both). In various embodiments, the controllers 111, 121, 131 may each further include any non-transitory memory known in the art. The memory may store instructions usable by the logic device to perform operations. Any appropriate computer-readable type/configuration may be utilized as the memory, any appropriate data storage architecture may be utilized by the memory, or both.

In various embodiments, each PSU (e.g., PSUs 110, 120, 130) may comprise a release mechanism (e.g., release mechanism 112, 122, 132), an oxygen source (e.g., oxygen source 113, 123, 133), and oxygen mask assemblies (e.g., oxygen mask assemblies 114, 124, 134, 144). In various embodiments, the controller 102 may command the various local controllers (e.g., controllers 111, 121, 131) to instruct the devices therein. For example, the controller 102 may command the release mechanisms 112, 122, 132 to release the oxygen mask assemblies 114, 124, 134, command the oxygen source 113, 123, 133 to activate, etc.

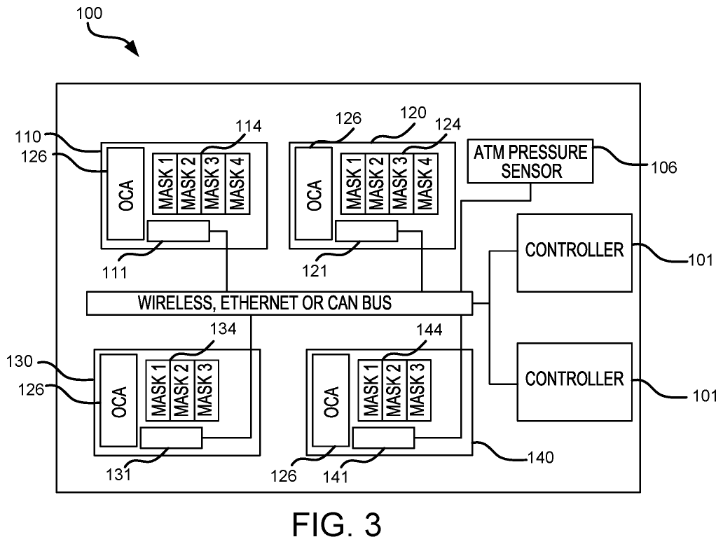

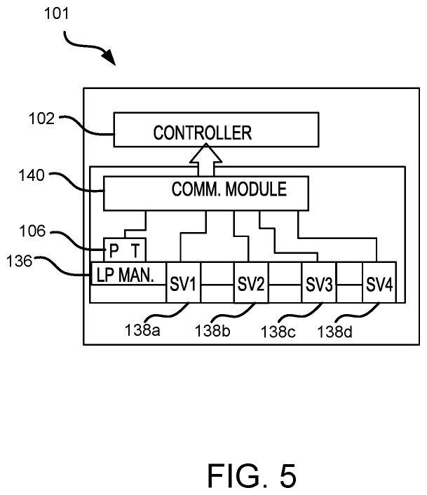

Referring now to FIG. 3-5, in various embodiments, the oxygen system 100 includes an oxygen cylinder assembly (OCA) 126. In various embodiments, the OCA 126 may be located inside the oxygen box of the plurality of PSUs 110, 120, 130. The OCA may be connected to the oxygen mask assemblies 114, 124, 134. The OCA 126 may comprise of a high pressure oxygen bottle, pressure regulator and electrical or mechanical initiator. The PSUs 110, 120, 130 may further comprise a low pressure manifold 136 and at least one solenoid or proportional valve 138. The solenoid valve 138 is configured to dispense oxygen to the mask assemblies 114, 124, 134. For instance, a first solenoid valve 138a is connected to mask assembly 114, a second solenoid valve 138b is connected to mask assembly 124, a third solenoid valve 138c is connected to mask assembly 134, and a fourth solenoid valve 138d is connected to mask assembly 144. The controller 102 may be configured to monitor the manifold pressure and temperature of the oxygen system 100. For instance, as shown in FIG. 5, a schematic of a main centralized intelligent controller (e.g., main controller 101), the main controller 101 may include a communications module 140. The communications module 140 is configured to determine a pressure and/or temperature reading from sensors 106 and send a signal to the PSUs 110, 120, 130 in response to the determination. The communication modules 140 of the main control system 101 is further configured to initiate the OCA 126 and manage the delivery of oxygen to the passengers.

Activation of an individual passenger interface is accomplished by selecting a face mask and breathing thereinto. An exhalation is detected by a sensor (e.g., sensor 106) which causes controller 101 to open the inlet valve that is associated with the face mask to allow the influx of oxygen. For instance, in various embodiments, the oxygen system 100 includes reservoir bags such that the inlet valve that is associated with the face mask allows the influx of oxygen into the associated reservoir bag. The controller 101 is configured to calculate the volume of oxygen needed in light of the ambient cabin pressure measured via an ambient pressure sensor and closes the inlet valve after an appropriate period of time. In various embodiments, the controller 101 is configured to calculate the volume of oxygen needed in light of a rate of airflow (e.g., a passenger's breathing pattern) being above a predetermined threshold. The system's oxygen pressure may be regulated to a level such that the desired volume of oxygen is deliverable to the reservoir bag well within the period of time needed for exhalation. During the passenger's post-expiratory pause, the delivered oxygen may be held in the reservoir bag. Upon inhalation, the inhalation valve allows all the oxygen within the reservoir bag to be inhaled to fill the passenger's lower lung lobes where the most efficient oxygen transfer takes place. Upon depletion of the contents of the reservoir bag, further inhalation causes the mask's dilution valve to open so as to allow the passenger's respiratory demand to be satisfied by ambient cabin air. Exhalation causes the sequence to repeat. In various embodiments, the controller 101 is configured to deliver oxygen without the reservoir bag.

In other words, the face mask (e.g., face mask assemblies 114, 124, 134, 144) are configured to facilitate a flow of the accumulated volume of oxygen from the source of oxygen (e.g., OCA 126). Contemporaneously, the sensor 106 detects at least one of an ambient pressure, an airflow through the face mask in a first direction, or an airflow through the face mask a second direction. For instance, airflow in the first direction may indicate an inhale by the passenger and airflow in the second direction may indicate an exhale by the passenger. Then the controller 106 may determine at least one of the ambient pressure, the airflow being in the first direction, or the airflow being in the second direction, and command delivery of oxygen from the source of oxygen to the face mask in response to the determination. For instance, the inlet valve of the passenger service unit (e.g., PSU 110, 120, 130, 140) remains closed with the airflows in the first direction, and the controller controllers the inlet valve to open in response to the airflow flowing in the second direction.

The configuration of the system causes the frequency with which the oxygen is delivered to match the frequency of the respiratory rate of the passenger breathing therefrom. Should the volume of oxygen that is received by a particular passenger fail to satisfy that particular passenger's oxygen demand, the respiratory rate would be expected to increase to thereby increasing the frequency with which the allotments of oxygen are delivered to the passenger. Conversely, should the volume of oxygen that is received by a particular passenger during each respiratory cycle exceed such passenger's oxygen requirement, the passenger's respiratory rate would be expected to decrease, thereby decreasing the net flow of oxygen to the passenger.

By substantially matching the delivery of oxygen to a passenger's demand therefor, the efficiency of an emergency oxygen supply system is maximized and oxygen consumption is minimized. Such an increase in efficiency allows the size of the oxygen supply to be reduced when compared with less efficient systems such as are currently in use and thereby allows a substantial weight reduction to be realized. The weight reduction in turn translates into a reduction in an aircraft's fuel consumption and/or an increase in payload capacity.

Further, the use of an intelligent controller (e.g., main control system 101 with controller 102) allows for the implementation of more sophisticated predictive control algorithms that can better account for breathing variabilities between passengers. Controller 102 may further be configured to calculate the remaining oxygen in the bottle and predict when the bottle will be depleted and generate a notification accordingly. Having the centralized controller 102 creates more space in the PSU to increase the amount of stored oxygen, or provide more space for masks which will help reduce tangles during deployment.

Accordingly, as described herein the controller 102 is configured to controller the plurality of PSUs 110, 120, 130 in lieu of the local controller (e.g., controllers 111, 121, 131). The oxygen system 100 may be configured to have the capacity to support the plurality of controllers 102 such that, if an intelligent controller fails, then its responsible oxygen panels will be reassigned to other controllers. The oxygen system 100 thus provides redundancy in a safety critical system. Additionally, the controller 102 may be configured to perform health monitoring, and report issues to the flight crew or schedule maintenance. Health status and operational status can be sent to a flight crew screen and inform them if one panel or valve is not operational so that the crew member can act accordingly. The oxygen system 100 may be integrated with other smart interior systems to provide information to the flight crew without duplicating hardware components. In various embodiments, a plurality of intelligent controllers (e.g., controller 102) may be used to dispense oxygen to passengers.

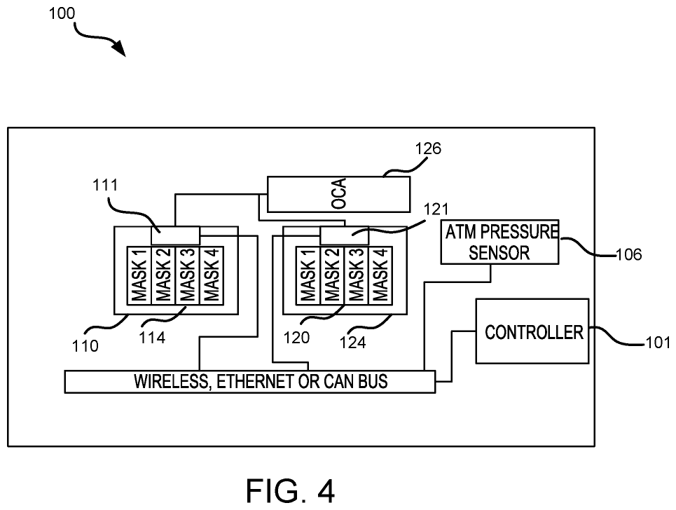

Referring now to FIG. 4, in various embodiments, the OCA 126 may be located outside of the oxygen box of the plurality of PSUs 110, 120, 130. The OCA 126 may be connected to the oxygen panels with plastic or steel flexible tubing, along with quick disconnects or threaded connections. In such configuration, the weight of the oxygen system 100 is reduced by reducing the number of OCAs on the aircraft, and larger lighter weight composite cylinders may be used in the oxygen system 100. Further, removing the OCAs from the PSUs will allow for a more reliable mask pack and easier maintenance checks.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. An oxygen supply system for delivering oxygen to passengers in an aircraft in an event of a loss of cabin pressure, comprising:
a source of oxygen;
a passenger service unit comprising:
a face mask configured to facilitate a flow of an accumulated volume of oxygen from the source or a bolus of oxygen; and
a sensor configured to detect at least one of an ambient pressure, an airflow in a first direction, or an airflow in a second direction; and
a main controller operatively coupled to the passenger service unit, the main controller configured to:
determine at least one of the ambient pressure, the airflow being in the first direction, or the airflow being in the second direction; and
command delivery of oxygen from the source of oxygen to the face mask in response to the determination.

2. The oxygen supply system of claim 1, further comprising a plurality of passenger service units, wherein the main controller is configured to control each of the plurality of passenger service units.

3. The oxygen supply system of claim 2, wherein the source of oxygen supplies each of the plurality of passenger service units.

4. The oxygen supply system of claim 1, wherein the source of oxygen comprises a container of compressed oxygen gas.

5. The oxygen supply system of claim 1, wherein an inlet valve of the passenger service unit remains closed in response to the airflow being in the first direction.

6. The oxygen supply system of claim 5, wherein the inlet valve is opened in response to the airflow being in the second direction.

7. The oxygen supply system of claim 6, wherein the accumulated volume of oxygen is delivered to a reservoir bag coupled to the face mask prior in response to the airflow being in the second direction to meter a constant flow.

8. The oxygen supply system of claim 7, wherein the main controller is configured to open and close the inlet valve.

9. The oxygen supply system of claim 8, wherein the main controller is configured to determine a volume of oxygen as a function of at least one of the ambient pressure or a rate of airflow being above a predetermined threshold.

10. An article of manufacture including a tangible, non-transitory computer-readable storage medium having instructions stored thereon for controlling a passenger service unit, in response to execution by a controller, cause the controller to perform operations comprising:
determining at least one of an ambient pressure of an aircraft cabin or an airflow through a face mask in a first direction, or an airflow through the face mask in a second direction; and
commanding delivery of oxygen from a source of oxygen to the face mask in response to the determination.

11. The article of manufacture of claim 10, wherein the passenger service unit comprises the face mask and a sensor, wherein the face mask is configured to facilitate a flow of an accumulated volume of oxygen from a source of oxygen, and the sensor is configured to detect at least one of the ambient pressure, the airflow being in the first direction, or the airflow being in the second direction.

12. The article of manufacture of claim 11, wherein the controller is configured to communicate with the sensor such that the operations further comprise receiving data from the sensor, the data indicative of at least one of the ambient pressure of the aircraft cabin, the airflow being in the first direction, or the airflow being in the second direction.

13. The article of manufacture of claim 10, wherein the operations further comprise controlling a plurality of passenger service units, wherein the controller is operatively coupled to each of the plurality of passenger service units.

14. The article of manufacture of claim 13, wherein the operations further comprise commanding delivery of oxygen from the source of oxygen to each of the plurality of passenger service units.

15. The article of manufacture of claim 10, wherein the source of oxygen comprises a container of compressed oxygen gas.

16. The article of manufacture of claim 11, wherein the operations further comprise commanding an inlet valve to open and commanding the inlet valve to close.

17. The article of manufacture of claim 16, wherein the inlet valve of the passenger service unit remains closed in response to the airflow being in the first direction.

18. The article of manufacture of claim 17, wherein the inlet valve is opened in response to the airflow being in the second direction.

19. The article of manufacture of claim 18, wherein the accumulated volume of oxygen is delivered to a reservoir bag coupled to the face mask in response to the airflow being in the second direction to meter a constant flow.

20. The article of manufacture of claim 19, wherein the operations further comprise determining the volume of oxygen as a function of at least one of the ambient pressure or a rate of airflow being above a predetermined threshold.
